(19) United States
(12) Patent Application Publication
(10) Pub. No.: US 2007/0250851 A1
(43) Pub. Date: Oct. 25, 2007

(54) SYSTEM AND METHOD FOR IDENTITY VERIFICATION AND ACCESS CONTROL USING A CELLULAR/WIRELESS DEVICE WITH AUDIOVISUAL PLAYBACK CAPABILITIES

(76) Inventor: Zvi Haim Lev, Tel Aviv (IL)

Correspondence Address: SUGHRUE MION, PLLC, 2100 PENNSYLVANIA AVENUE, N.W., SUITE 800, WASHINGTON, DC, 20037, US

(21) Appl. No.: 11/550,270

(22) Filed: Oct. 17, 2006

Related U.S. Application Data
(60) Provisional application No. 60/727,558, filed on Oct. 18, 2005.

(51) Int. Cl. H04N 7/167; H04N 7/16

(52) U.S. Cl. 725/25; 725/30; 725/31

(57) ABSTRACT

A system and method for qualifying a user of a service or product, a reference source of data, a source of user data, and a qualifying module that compares the data from such reference source to the data from said user data to see if there is a match, in which a user approaches a point of sale, the user contacts a server, the server checks if the user may access the service or product, the server transmits content to the user and to a controller, the controller compares the data from the source of user data to data from the reference source of data, and the controller then qualifies or rejects the user to receive the service or product.

### CROSS-REFERENCE TO RELATED APPLICATIONS

This application claims the benefit of U.S. Provisional Patent Application Ser. No. 60/727,558, filed on Oct. 18, 2005, entitled “System and method for identity verification and access control using a cellular/wireless device with audiovisual playback capabilities”, which is incorporated herein by reference in its entirety.

### BACKGROUND OF THE EXEMPLARY EMBODIMENTS OF THE INVENTION

1. Field of the Exemplary Embodiments of the Invention

The present invention relates generally to the field of identity verification and access control. In numerous instances, such as points of sale, or physical entry points such as entrance to a club, train, etc., there is a need for a fast and reliable system and method for enabling a person or automated mechanism to grant access/services to users who are entitled while rejecting users who are not entitled. Common examples would be train tickets where the physical ticket serves for access control, movie tickets, ID cards for various events, etc. Some exemplary embodiments of the current invention provide an alternative or complementary method of accomplishing the same goal based on the ability of mobile devices to play audiovisual content which was sent to them in advance or which is streamed to them in real time, and the ability of people (and automated devices) to quickly and reliably compare such content to a “reference” source. Thus, by proving that a user's device has access to this special restricted access audiovisual source, the user establishes his or her identity, and entitlement to access.

The embodiments described herein are illustrative and non-limiting. Definitions are provided solely to assist one of ordinary skills in the art to better understand these illustrative, non-limiting embodiments. As such, these definitions should not be used to limit the scope of the claims more narrowly that the plain and ordinary meaning of the terms recited in the claims. With that caveat, the following definitions are used:

“Audiovisual content stream” or “content stream” is any digital content that has audio and/or visual components that can be encapsulated in a video/audio format, e.g., a tune, a series of images, streaming video, etc. This content is time changing on a continuous basis—thus, it is easy to differentiate between two such content streams played with a relative delay between them.

“Computational facility” means any computer, combination of computers, or other equipment performing computations, that can process the information sent by the handheld device. Prime examples would be the local processor in the imaging device, a remote server, or a combination of the local processor and the remote server.

“Controller” means a person, an animal, or a machine controlling whether or not the applicant should receive the service required. Examples are security personnel, trained dogs, ushers in a cinema, a computerized access control system, etc.

“Displayed” or “printed”, when appearing in conjunction with an imaged document, is intended expansively to mean that the document to be imaged is captured on a physical substance (as by, for example, the impression of ink on a paper or a paper-like substance, or by embossing on plastic or metal), or is captured on a display device (such as LED displays, LCD displays, CRTs, plasma/TFT displays, ATM displays, meter reading equipment or cell phone displays).

“Handheld device” means any equipment for digital content reception and playback including, for example, 2G/3G mobile phones, a PC, a mobile TV receiver, an MP3/MP4 media player, a PDA etc. Reference to a handheld device includes the user of the handheld device.

“POS” (acronym for Point of Sale) means access control point/point of sale. Some examples of POS are access control at a work place and sensitive areas, tickets checking in the theaters and museums, coupon verification in the retailing business, remote access points with videoconferencing capabilities, direct banking, and ATM devices

“User” is the handheld device user. The handheld device user may also be a human user of some automatic system such as a robot.

“Video call” means two-way and one-way video calls, performed via computers with web-cams or a cell phone with camera or any other device with the capability of audio or audiovisual capture, including (but not by way of limitation) any connection performed by imaging device with video streaming capability, and any connection and sending of a stored video data

“Real Time” or “Semi Real Time” in the context of an audiovisual content stream, means that the average delay between the content stream as sent by the originating server and the content stream as played by the receiving device may be hundreds of milliseconds but in any case is not more than several thousands of milliseconds.

2. Description of the Related Art

The issue of reliable, cost effective and fast methods of proving identity and/or entitlement to services is a key factor in the design and implementation of points of sale and physical access control methods. Some traditional methods include: printed tickets, physical ID cards, color stamps that can be attached to a user's cloths or skin, magnetic cards, RFID chips, etc. There are also biometrics-based methods which involve establishing the user's identity based on physical parameters of the user's body such as retina image, fingerprints, DNA chips, voice/face identification.

In recent years, several methods have been proposed and implemented that utilize the users' wireless mobile devices for these purposes. The “ticket” or voucher provided to the user is often referred to as an “e-ticket” or “e-coupon”. Some examples include:

### EXAMPLE 1

Sending a text message (SMS) to mobile phones of users. These messages can contain a unique code or a generic code.

### EXAMPLE 2

Sending a multimedia message containing machine readable codes (e.g., barcodes) that can be scanned by a proper apparatus at the point of sale/access control point (e.g., a barcode reader).

The advantages of these methods over traditional paper based methods are:

1. The access information is stored on the user's mobile device, which presumably the user carries at all times, hence it is not easily lost or forgotten like a paper ticket, coupon, or other tangible medium.

2. The distribution of the access tokens to the users is relatively low cost of sending an SMS or MMS message.

3. The user can “carry” in a single mobile device dozens and hundreds of such “e-tickets” with no extra weight/volume.

4. It is possible to verify the sending and/or re-send “e-tickets” to the user.

5. The ticket distribution is fast and can be verified using the wireless network.

At the same time, there are some known disadvantages to these methods:

1. The verification process at the POS can be time consuming and arduous compared to physical ticket inspection—the person in charge may need to look at the small screen of the user's mobile device, read the tiny letters, etc.

2. Automatic inspection of e-tickets is a complicated and non-accurate procedure. For example, inspecting barcodes on cellular phone displays is problematic with standard barcode readers well known in the art, due to the screen properties on such readers. Hence, special purpose devices must be purchased and installed.

3. Special equipment may be necessary for the verification, such as, for example, barcode readers.

These disadvantages are critical to the economic validity of the “e-ticket” deployment process, since the time required to validate those tickets and the costs associated with checking them form an important part of the total cost of such access control/point of sale operations.

Another existing user authentication system, which could be used for eligibility verification, is that of time changing or one-time-codes displayed by a handheld device based on some secure mechanism. These codes can be verified at a POS, which is an advantage of the system. Examples of such systems are provided by UbiSecure Solutions, Inc. and Diversinet, Inc. Some disadvantages of such systems are:

They require special software to be installed on the handheld device.

The verification of an alphanumeric code requires either that the user type the code on some terminal at the POS, or that a POS operator read the code and compares it to a reference. In both cases, close physical proximity to the user's handheld device, and considerable time, are required.

### SUMMARY OF EXEMPLARY EMBODIMENTS OF THE INVENTION

One aspect of the exemplary embodiments of the present invention solves these deficiencies of current “e-ticketing” mechanisms by providing a mechanism which does not require new specific hardware at the POS, does not require software installation on the handheld device, and which enables quick and easy verification.

The exemplary embodiments of the present invention rely on the use of audio and video capabilities available in handheld devices to enable identification or access control at a POS. A handheld device will display or play some easily identifiable content. This content is only made available to an eligible handheld device, and the identification of this content by the access control person or system will serve to prove the eligibility of the user in possession of this device. The content serves as a type of audio-visual version of a regular printed ticket. Where a regular printed ticket is protected from copying and forgery by construction materials, print format and quality, and potentially other physical means, the audio-visual ticket is protected by the inability of users to copy and forward it to others, and the inability of ineligible users to obtain it independently.

The verification process at the POS relies on an audiovisual comparison (human or automated) between the content played by the handheld device and some reference source. The relative immunity to forgery/copying comes from the fact that the content is sent to the eligible handheld devices in real time (or near real-time) and is unknown to the users before that time. Hence, forgery is prevented, as the content is not known in advance. Similarly, no copying can take place, since the time to copy and send the content would create a noticeable delay in the content stream as compared to the reference source.

Some exemplary differences between related art and the exemplary embodiments of the present invention are thus:

Utilization of the Timing element—the exemplary embodiments of the present invention utilize a content stream which is sent to the user device and played by the user's device in real time or semi real time and thus cannot be copied, manipulated, or forwarded to other ineligible devices without generating a significant and noticeable time delay.

Simplification of the authentication process—since the content sent to the user device is protected from copying and forwarding by the timing element, the actual content can essentially be any audio-visual content, and can be verified quickly and easily to correspond to the reference content stream, similarly to present day paper-ticket verification by short visual inspection. Authentication may then be used for services such as identification and access control.

Utilization of additional means for qualification—since one aspect of the exemplary embodiments of the invention is the generation and comparison of audiovisual data streams from two sources, the qualifying module may include additional comparison tests, such as synchronization matching and audiovisual matching.

Additional differences between the related art and the exemplary embodiments of the present invention, and additional advantages of the exemplary embodiments of the present invention over the related art, are explained further herein in the specification and claims.

### BRIEF DESCRIPTION OF THE DRAWINGS

Various other objects, features and attendant advantages of the exemplary embodiments of the present invention will become fully appreciated as the same become better understood when considered in conjunction with the accompanying detailed description, the appended claims, and the accompanying drawings, in which:

FIG. 1 is a schematic diagram of the various system components of a related art system.

FIG. 2 is a schematic diagram of the various system components of an exemplary embodiment of the system proposed in this invention. As explained below, FIG. 2 shows one possible configuration of the elements by which the audiovisual content travels in the system.

FIG. 3 is a schematic diagram of the various components of an exemplary embodiment of the system proposed in this invention. As explained below, FIG. 3 shows one possible configuration of the elements by which the audiovisual content travels in the system.

FIG. 4 is a schematic diagram of one possible audiovisual content qualification method in an exemplary embodiment of the invention.

### DETAILED DESCRIPTION OF THE EXEMPLARY EMBODIMENTS

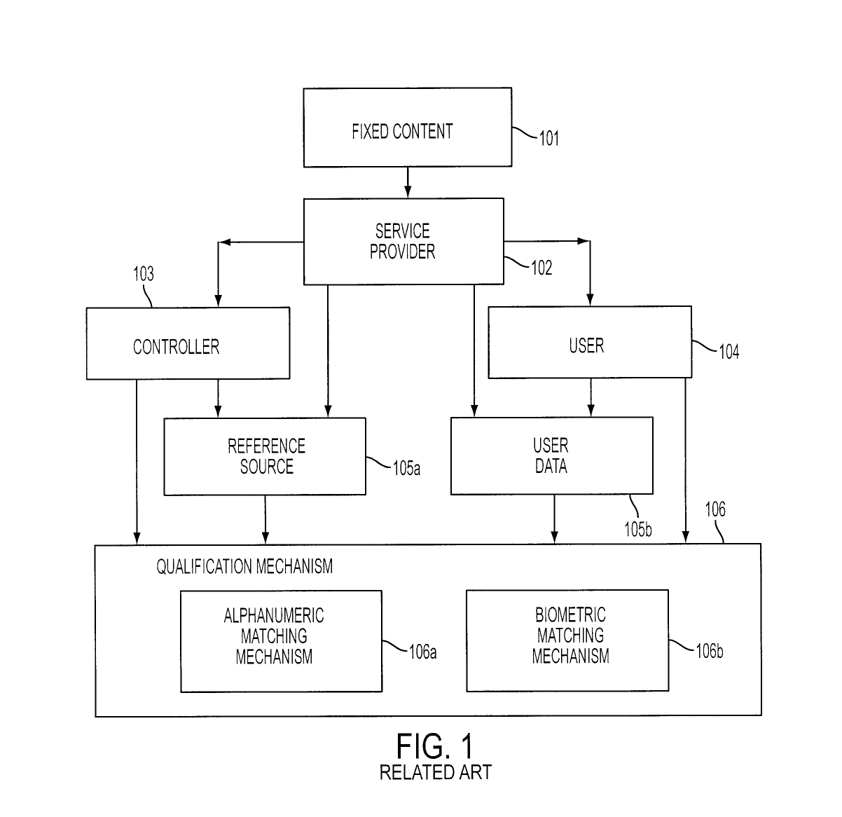

An exemplary related art system is shown in FIG. 1.

Element 101: Fixed Content is content which a priori available for user identification. The term “fixed” refers to the fact that the content is sent to the user device before the user verification at the POS takes place. Hence, fixed content is known in advance of the time of verification, and may be copied or forwarded to qualification mechanism before or at the time of verification.

There are multiple types of content which can be used, separately or in combination, including:

Type 1: Physical content would be any physical (preferably hard to forge) object such as an ID card, a ticket, etc.

Type 2: Information content would be any information such as alphanumeric content (e.g., access code), a barcode, a photo, etc.

Type 3: Biometric content—would be physical information which is part of the user's body such as fingerprints, retina image, DNA, voice, face, etc.

Element 102: Service provider. The service provider manages the list of eligible users, their devices, and the audiovisual content required for the authentication. The service provider 102 is responsible for the distribution of this content 101 to the user 104. The typical user stores/displays this content 101 on a handheld device in form of user data 105b. The service provider 102 is also responsible for the distribution of this content 101 to the controller of the POS 103 in a form of the reference source 105a. The service provider 102 can also be involved in indirect communication between the user 104 and the controller 103. For example, the service provider may send the users some barcode or alphanumeric code which is either unique per user or a fixed message, and send the controller the authentication mechanism. Alternatively, the content 101 may be embodied in a form of user data 105b as a paper ticket inspected by the controller 103 at the POS. The service provider 102 may use any combination of the handheld device MSISDN number, IMEI number, IP address, passwords entered by the user, biometrics, or additional information to verify that the owner of this device is indeed eligible for the service. In fact, this is a part of the direct communication between the user 104 and the service provider 102. Only users with eligible devices will get the authentication content from the service provider 102. The service provider is also involved in direct communication with the controller 103, for example to initiate/facilitate the qualification mechanism 106 via some remote software.

Element 103: The controller 103 is responsible for the qualifying module 106, effectively checking the user data 105b vs. reference source content 105a. The qualifying module 106 can be initiated by any of three elements:

Initiation type 1: The controller 103 may initiate operation of the qualifying module 106 upon encounter with the user 104.

Initiation type 2: The user 104 may initiate the qualifying module 106 upon the user's arrival at the POS.

Initiation type 3: The service provider 102 may initiate the qualifying module 106 upon establishing communication with the user 104.

It should be understood that elements 105a reference source and 105b user data are sources of information by which the qualifying module 106 performs the qualification by comparing the fixed content of the reference source 105a to the fixed content of the user data 106a, but neither of these two elements 105a or 106a initiate operation of the qualification mechanism.

The reference source content 105a is available via the service provider 102 and, or alternatively, via the controller 103. For example, the reference source content may be the same alphanumeric code that the controller compares to the code provided by the user. It is important to note that the controller may have access to computational facilities enabling sophisticated authentication of the user content, by techniques such as verifying digital certificates or the encrypted content supplied by the user. The input from the service provider 102 may facilitate the qualifying module 106 via the following mechanisms:

Mechanism 1: Providing contextual information on the user. For example, the service provider providing the user entitled to 10% discount with green coupon and the user entitled to 20% discount with red coupon.

Mechanism 2: Providing the synchronization information. For example, the service provider may be providing a timestamp both on the reference source and in the user data.

Mechanism 3: Providing verification data on the user. For example, when the controller types in user identification number the controller gets a photo of the user.

Element 104: The user 104 has a handheld device which plays/displays the user data 105b which is provided from the service provider 102. The user 104 typically has direct communication to and from the service provider 102, in order for the user 104 to receive authentication from the server and/or the specific services to which the user is entitled. For example, the user might receive a special coupon in a form of promotional brochure from the service provider. The user may also initiate the qualification mechanism 106, say by pressing a button. Additionally, the user might be required to provide a verification input to the qualifying module 106, such as the maiden name of the user's mother,

Elements 105a, 105b: The reference source 105a and the user data 105b are two replicas of the same fixed content 101 available to the controller 103 and provided to the user 104. Both replicas are provided to the user and to the controller by the service provider 102 through some remote connection in material or electronic form. For the user 104 to successfully pass the qualifying module 106, 105a and 105b should be identical to each other or sufficiently similar in such a way that verifying that 105b is legitimate would be as simple and reliable as possible. If 105a and 105b are not identical or substantially identical, qualification will fail.

Element 106: The qualifying module is overseen by the controller 103 at the POS. The qualification mechanism is performed when the controller 103 compares reference source 105a with user data 105b to see if these two forms of fixed contact are replicas of one another. There are different qualification processes by which element 106 may operate, such as:

Element 106a: Alphanumeric matching mechanism assumes comparing two presumed replicas of alphanumeric fixed content 101. For example, the mechanism of comparing coupon number in the user's brochure to a number on controller's computer screen. Typically, perfect match is required for the user to succeed in the qualification process. So for example, if the user is asked the maiden name of his mother, the user's answer should be identical to the data available to the controller from the service provider.

Element 106b: Biometric matching mechanism assumes comparing and verifying additional content, such as the user's biometric data. For example, the mechanism of retina recognition in the airport provides for successful qualification. The addition of a second verification can serve to improve the reliability of the verification process.

The arrows between 103 and 106 are bi-directional, as are the arrows between 104 and 106, indicating that the process of qualification is iterative. Information is sent from the controller 103 to the qualifying module 106 and from the user to the qualifying module 106. Element 106 compares the two sources of data, and sends results to the POS controller 103 and the user 104. Further, if the qualifying module 106 requires further information or clarification (as if a data transmission is garbled and must be repeated), the qualifying module 106 may query the controller 102 or user 104 as required.

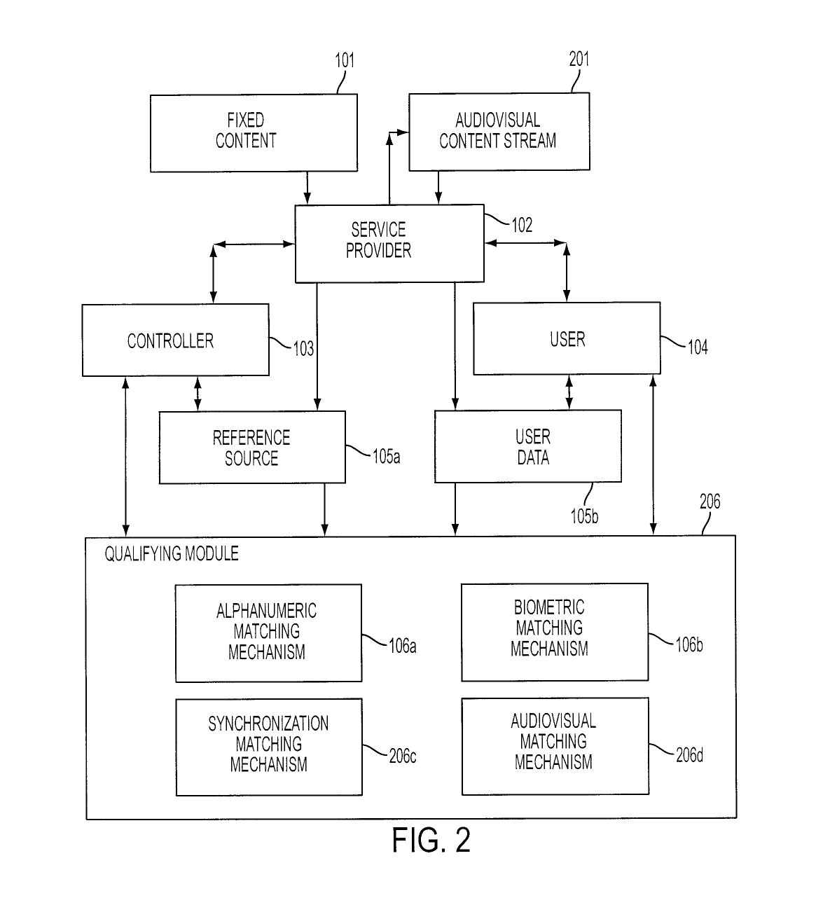

An exemplary embodiment of the present invention is given in FIG. 2.

Element 101: This element in FIG. 2 is analogous in structure, and performs in an analogous way, as element 101 in FIG. 1.

Element 102: This element in FIG. 2 is analogous in structure as in FIG. 1. The element also functions in an analogous way in FIG. 2 as in FIG. 1, except that in FIG. 2 it also communicates to and from an audiovisual content stream 201.

Element 201: This element is a content stream, and this element is not part of the related art. Element 201 may be, for example, an audiovisual content stream, or some variation such as a pure audio stream or a pure video stream. The content changes over time, so that a review of two versions of that content played at a delay one from the other, will clearly demonstrate the delay. The audiovisual content stream 201 can appear instead of 101 or together with 101 in various supplementing configurations, such as a printed coupon (example for 101) and a video call (example for 201). The audiovisual content stream 201 is typically generated by the service provider 102, or generated by a third party and modified by the service provider 102 for authentication purposes. Types of possible content modification include:

Content modification 1: Synchronization. For example, time stamp can be embedded to improve synchronization.

Content modification 2: Adaptation. For example, a logo can be embedded to fit the content for specific event context.

Content modification 3: Protection. For example, semi-transparent watermark can be embedded to eliminate copying efforts.

The original or modified content 201 is further distributed, typically in the form of video stream, by the service provider. There are, as depicted in FIG. 2, bi-directional arrow between element 201 and 102 indicating a possible feedback operation between these two elements, in which, for example, the service provider 102 provides data which is then modified at 201 into an audiovisual stream and then sent back to the service provider 102.

Element 103: The controller 103 has analogous structure and performs analogous functions in FIG. 2 as in FIG. 1.

Element 104: The user 104 has analogous structure and performs analogous functions in FIG. 2 as in FIG. 1.

Element 105a: The reference source 105a has analogous structure and performs analogous functions in FIG. 2 as in FIG. 1. However, it must be understood that the data provided by reference source 105a may be all or part of the audiovisual content stream 201 (in pure form or modified by 105a), or a combination of all or part of the fixed content 101 with all or part of the audiovisual content stream 201 (in which 101 or 201 may be modified by reference sources 105a).

Element 105b: The user data 105b has analogous structure and performs analogous functions in FIG. 2 as in FIG. 1. However, it must be understood that the data provided by reference source 105b may be all or part of the audiovisual content stream 201 (in pure form or modified by 105b), or a combination of all or part of the fixed content 101 with all or part of the audiovisual content stream 201 (in which 101 or 201 may be modified by reference sources 105b).

Element 206: Qualifying module 206 is analogous to the qualifying module 106 in FIG. 1, but the qualifying module 206 includes additional qualification sub-systems which are not part of the related art. In one exemplary embodiment, two additional sub-systems for qualification are the synchronization matching mechanism 206c and the audiovisual matching mechanism 206d.

Element 206c: The synchronization matching mechanism 206c between the two sources of information, namely reference source 105a and user data 105b, allows measuring the delay between these two sources to determine if they are replicas of each other. Since any fraud effort requires time, synchronization matching 206c is an effective antifraud device. For example, in a present day wireless network, the delay or multimedia transmission between two mobile devices would be on the order of 1,000 milliseconds or more. Hence, if a user with an eligible device receiving the content stream were to transmit the content stream to another user (where this other user is ineligible to receive the content stream or the corresponding service), the time delay between the content streams on these two respective devices (that is, between the eligible device and the ineligible device) would be on the order of 1,000 milliseconds or more, a delay that is clearly discernible by people or by automated means. Then, when the reference data 105a is compared to the ineligible device's user data 105b, the delay will cause the qualifying module 206 to find no match, and to deny validation or service to the ineligible device.

Element 206d: Audiovisual matching mechanism is a fast way to compare the two sources of information available from namely 105a and 105b, making the qualification mechanism faster and more reliable. The matching 206d is straightforward, for example, comparing visually two synchronized films in video streaming mode. The reference source 105a and the user data 105b can be, for example, an audiovisual content stream 201 in the form of a film multi-casted to an array of receiving handheld devices. It is important to note that the comparison operation does allow for additional information to be displayed by content stream 105b of the user. For example, 105a and 105b could be a music video clip of a band, while 105b also displays on top of the music video clip some information (e.g., the type of ticket the user has purchased, the user's name, photo etc.). The addition of information in 105b does not alter the match between the sources in 105a and 105b, but simply gives to the user some additional information. Similarly, additional information may be provided by reference source 105a, perhaps for purposes of security or to ease seating, but any additional information at source 105a will not alter the match between the sources in 105a and 105b.

In general, it should be understood that although the exemplary embodiment described in FIG. 2 herein typically operates in the manner described above, alternative exemplary embodiments of the invention may operate in a different manner, as indicated by the bi-directional arrows between the elements. For example, typically the service provider 102 provides content to the controller 103, but the arrows between these two elements are bi-directional, indicating that in alternative embodiments of the invention, the controller may query the service provider to initiate a qualification or for information additional to that conveyed originally from the service provider 102 to the controller 103. This kind of feedback alternative embodiment also appears in the bi-directional arrows between pairs of elements 102 and 201, 102 and 103, 103 and 105a, 103 and 206, 102 and 104, 105 and 105b, and 104 and 206.

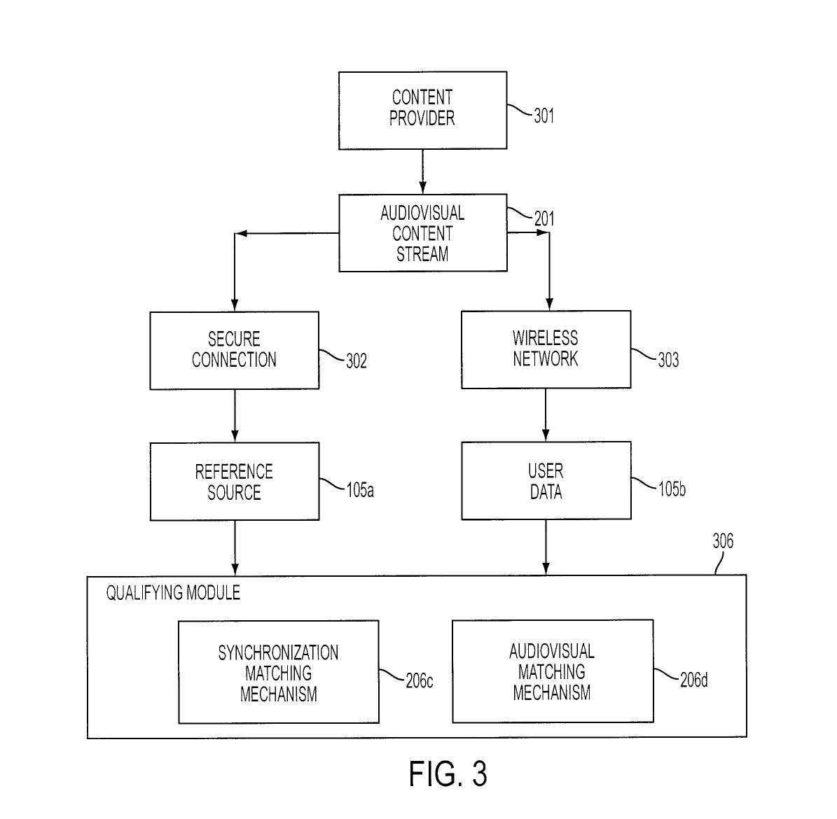

Another exemplary embodiment of the invention is given in FIG. 3:

Element 301: The content provider generates an audiovisual sequence which contains some visual content with added value for the particular service. For example, if the service is to allow entry to a cinema theater, the audiovisual sequence may be a movie trailer. In order to facilitate data synchronization comparison for a short audiovisual sequence, it is useful to imprint some form of a time display in a random position of the movie sequence.

Element 201: This element in FIG. 3 is analogous in structure and content as in FIG. 2. Element 201 in FIG. 3 differs from the element in FIG. 2 in that in FIG. 3 it communicates with the content provider 301, with the secure connection 302, and with the wireless network 303, rather than with the service provider 102. In FIG. 3, the audiovisual content stream 201 is transmitted through two separate networks 302 and 303, as explained below.

Element 302: The secure connection transmits the data from the content provider 301 to the reference source 105a. For example, a movie trailer, which may be an example of 201 in FIG. 3, appears on a closed circle monitor in the controller's booth. The bi-directional arrows between 302 and 201 indicate there is a feedback mechanism by which 302 may ask for retransmission, or may query 201 for additional information.

Element 303: The wireless connection transmits the audiovisual content to the user data 105b at the user's handheld device. The user data 105b should be identical or substantially identical to 105a for the qualification mechanism 306 to provide validation. The two types of visual qualification 206c and 206d involve comparing the audiovisual streams of 105a and 105b. If there is a large delay between these video streams, there might be a fraud attempt. The bi-directional arrows between 303 and 201 indicate there is a feedback mechanism by which 303 may ask for retransmission, or may query 201 for additional information.

Element 105a: The reference source 105a has analogous structure and performs analogous functions in FIG. 3 as in FIG. 1. However, in FIG. 3, reference source 105a receives information from the secure connection 302 and sends information to the qualification mechanism 306.

Element 105b: The user data 105b has analogous structure and performs analogous functions in FIG. 3 as in FIG. 1. However, in FIG. 3, reference source 105b receives information from the wireless network 303 and sends information to the qualifying module 306.

Element 306: Qualification system or qualifying module 306 is analogous to qualification 106 in FIG. 1, except that 306 includes only the two qualification sub-systems synchronization matching system 206c and audiovisual matching system 206d, where 206c and 206d in FIG. 3 have analogous structure and perform analogous functions as in FIG. 2. In FIG. 3, there is no controller, so results of the match made in 306 are viewed or examined directly at 306, and thus there is no communication from 306 to either 105a or 105b.

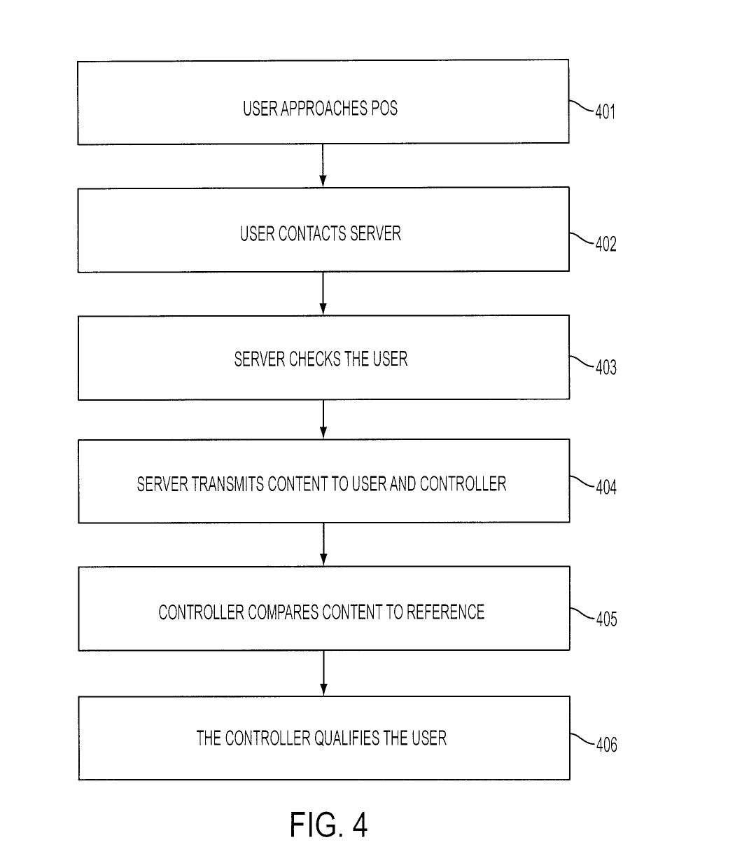

An exemplary method for audiovisual qualification process is described in FIG. 4.

Element 401: User approaches the POS. In one exemplary embodiment, the user 104 should be in visibility and/or hearing range of the controller 103 at the POS. Alternatively, the connection between the user and controller may be through some remote network with audiovisual capabilities.

Element 402: User contacts the content server, in which the content server is an exemplary embodiment of the service provider 102. The user generates some contact with the remote center of service provider 102 through placing a video call, or by opening a relevant connection through a wireless network 303, or by some other means of transmitting information to the service provider 102.

Element 403: The service provider 102 checks the user. This means that the service provider 102 checks certain data to see that the user is indeed entitled for the service. All required data is typically available in the user handheld device or known to the user. Some such data could be the MSISDN number of the mobile device, or user biometrics, or a password. In some cases, some of the data becomes available to the user only at the POS via the qualifying module 206 or through some third-party service. If the user is checked at stage 403 and found to be eligible, then and only then will the service provider 102 provide audiovisual content to the user, as described below.

Element 404: The remote server of the service provider 102 transmits the audiovisual content 201 to the user and controller. The content typically includes some built-in synchronization information and additional antifraud mechanisms, introduced by the service provider 102 to the content 201. These antifraud mechanisms include content specific to situation, such as time, location, user data, controller data, or service provider data. It is hard to duplicate the situation-specific content via a generic recording device. Thus, the content specific to a situation provides some content protection. Usually it is important that the delay of the network between the server and the user is sufficiently low to allow significant output of the audiovisual content synchronization matching mechanism 206c.

Element 405: The controller 103 views the content from the audiovisual content stream 201. In one exemplary embodiment, two versions of the same content 105a and 105b are available to the controller with the same delay. The reference source data 105a may be supplied by a secure connection 302. In low-security applications, it is possible that the connection used by the controller 103 is identical to the connection used by the device, possibly a handheld mobile device, of the user 104.

Element 406: The controller 103 qualifies the user 104. In one exemplary embodiment, an electronic qualification, such as audiovisual matching by 206d, is backed up by some physical element matching, such as ticket number alphanumeric matching 106a. In that case, the qualification process may include not just subjective audiovisual match but also additional methods.

Once the user 104 is qualified for the service by the controller 103, the transaction takes place. The user then finishes the connection with the service provider 102. The service provider 102 may also receive a feedback from the controller 103. In this way, there is a possibility of keeping some statistics by the server service provider 102, such as, for example, of time-to-response and service quality of the controller.

The following application examples demonstrate particular embodiments of the method in FIG. 4.

Application example 1: Cinema entry.

Stage 1, corresponding to element 401: User approaches access control point, say the cinema theater entrance.

Stage 2, corresponding to element 402: The user calls a predefined number in a video call.

Stage 3, corresponding to element 403: The remote server at the other side of the video call verifies that the user has purchased a ticket previously to the event. During the recognition process the user receives entertaining and promotional video from the server.

Stage 4, corresponding to element 404: The server starts transmitting special content in real time to the phone via a video call, and to the controller via a data connection.

Stage 5, corresponding to element 405: The usher compares the video clip playing on the phone to a reference video source.

Stage 6, corresponding to element 406: If the user content is the same and it is played at the same time as the source video, the access is granted.

Application example 2: Electronic coupon.

Stage 1, corresponding to element 401: User approaches a point of sale.

Stage 2, corresponding to element 402: The user opens a pre-existing WEB/WAP link.

Stage 3, corresponding to element 403: The remote server detects the RTSP request, and checks which product the user is eligible for.

Stage 4, corresponding to element 404: The remote server sends back a video feed with the product ID and user details superimposed on the video.

Stage 5, corresponding to element 405:

Phase 1: The cashier compares the video on the phone screen to a video reference source.

Phase 2: The cashier determines which product is required based on the superimposed text on the video.

Stage 6, corresponding to element 406: The user identity is further verified by text such as e.g. “John Smith, middle aged, black hair, middle height, ID card number 2999288323”. Once user identify it verified, the user will receive the product or service, in this case, access to an event.

Application example 3: Event access.

Stage 1, corresponding to element 401: User approaches a point of sale.

State 2, corresponding to element 402: User opens a pre-existing RTSP link.

Stage 3, corresponding to element 403: The remote server detects the WTP/HTTP request, verifies that the user has purchased a ticket previously to the event.

Stage 4, corresponding to element 404: The server sends back to the user's browser an image from set of predefined images, and sends this image to the controller.

Stage 5, corresponding to element 405: The cashier compares the image on the phone screen to a printed displayed set of images from the reference source. If one of the images on the reference source matches the image in user's browser, the image is marked so it will not be used again.

Stage 6, corresponding to element 406: If the image on the phone screen matches the reference source data, the cashier qualifies the user by asking his personal ID number, and then grants, to the user, the product or service, in this example access to the event.

The foregoing description of the aspects of the exemplary embodiments of the present invention has been presented for purposes of illustration and description. It is not intended to be exhaustive or to limit the present invention to the precise form disclosed and modifications and variations are possible in light of the above teachings or may be acquired from practice of the present invention. The principles of the exemplary embodiments of the present invention and their practical applications were described in order to explain and to enable one skilled in the art to utilize the present invention in various embodiments and with various modifications as are suited to the particular use contemplated. Thus, while only certain aspects of the present invention have been specifically described herein, it will be apparent that numerous modifications may be made thereto without departing from the spirit and scope of the present invention.

What is claimed is:

1. A system for qualifying a user of a service or product, the system comprising:
a controller that stores a reference source of data;
a user device that stores a source of user data; and
a qualifying module that compares the data from said reference source to the data from said user data to see if there is a match,
wherein the reference data and the user data each comprise an audiovisual content stream.

2. The system of claim 1, wherein:
said audiovisual content stream of the reference source of data changes over time to be compared to another audiovisual content stream to determine relative timing of transmissions of the two audiovisual content streams;
said audiovisual content stream of the user data changes over time to be compared to another audiovisual content stream to determine the relative timing of transmissions of the two audiovisual content stream; and
said qualifying module compares the audiovisual content stream of the reference source of data to the audiovisual content stream of the user data, to determine the relative timing of transmission of the two audiovisual content streams.

3. The system of claim 2, the system further comprising:
a service provider that provides said audiovisual content stream of the reference source to a controller; and
said service provider provides said audiovisual content stream of said user data to a user.

4. The system of claim 3, wherein:
said controller provides information from said reference source to said qualifying module.

5. The system of claim 4, wherein:
said user has a user device; and
said user device receives said user data and transmits said user data to said qualifying module.

6. The system of claim 5, wherein the qualifying module comprises
a synchronization matching mechanism that compares the timing of transmission for the audiovisual content stream from the reference source and the audiovisual content stream from the user data; and
an audio visual matching mechanism that allows visual and audio comparison of the data from audiovisual content stream of the reference source to the data of the audiovisual content stream from the user data.

7. The system of claim 6, wherein:
the reference source and the source of user data each provide alphanumeric data;
the qualifying module further comprises an alphanumeric matching mechanism that compares, for a match, the alphanumeric data from the reference source to the alphanumeric data from the source of user data.

8. The system of claim 6, wherein:
the reference source and the source of user data each provide biometric data; and
the qualifying module further comprises a biometric matching mechanism that compares, for a match, the biometric data from the reference source to the biometric data of the user data.

9. The system of claim 6, wherein:
the reference source and the source of user data each provide alphanumeric data and biometric; and
the qualifying module further comprises an alphanumeric matching mechanism that compares for a match the alphanumeric data from the reference source to the alphanumeric data of the user data; and
the qualifying module further comprises a biometric matching mechanism that compares for a match the biometric data from the reference source to the biometric data of the user data.

10. The system of claim 9, wherein the system includes a source of fixed content that is added to at least one audiovisual content stream and that is part of the qualification operation performed by the qualifying module.

11. The system of claim 9, wherein:
at least one the audiovisual content stream is transmitted via a secure connection to the reference source and to the qualifying module;
the user data is displayed on the user device;
said user device is a wireless device; and
a wireless network executes said transmission of the user data to said wireless user device.

12. The system of claim 9 wherein the audiovisual content stream comprises additional data that provides enhanced security.

13. The system of claim 9 wherein the audiovisual content stream comprises additional data that provides additional service to the user.

14. A method for qualifying a user of a product or service, the method comprising:
the user approaching a point of sale access point to become qualified to receive the product or service;
the user contacting a remote server to receive data by which the user is qualified to receive the product or service;
the server determining if the user is entitled to receive the product or service;
the server transmitting to the user, data content which may be compared for a match to reference data at a controller;
the controller comparing said data content to said reference data to determine if said data content matches the reference data; and
if said data content matches the reference data, the controller qualifying the user to receive the product or service.

15. The method of claim 14, wherein the user contacts the server via a wireless connection.

16. The method of claim 15, wherein the user contacts the server through an audiovisual call.

17. The method of claim 14, wherein, when the server transmits data content to the user, the server also transmits antifraud mechanisms, said antifraud mechanisms comprise at least one of: time of transmission information, location of the user information, data about the controller, and data about a service provider that provides data which is compared to information specific to the user.

18. The method of claim 14, wherein, when the user is qualified, the qualified user is granted access to an event or location.

19. The method of claim 18, wherein the even or location is an entertainment event.

20. The method of claim 14, wherein in addition to qualifying the user for a product or service, the method provides said point of sale additional information to enhance the product or service provided to the user.
